(19) United States
(12) Patent Application Publication
(10) Pub. No.: US 2024/0116827 A1
(43) Pub. Date: Apr. 11, 2024

(54) SELF-CLEANING CEMENTITIOUS SYSTEM AND METHOD

(71) Applicant: Purdue Research Foundation, West Lafayette, IN (US)

(72) Inventors: Maria Mirian Velay Lizancos, West Lafayette, IN (US); Vito Francioso, Lafayette, IN (US); Carlos Moro Martinez, San Marcos, TX (US); Marina Garcia Lopez-Arias, West Lafayette, IN (US)

(21) Appl. No.: 18/374,747

(22) Filed: Sep. 29, 2023

Related U.S. Application Data
(60) Provisional application No. 63/411,879, filed on Sep. 30, 2022.

(51) Int. Cl. C04B 41/00; C04B 28/04; C04B 28/08

(52) U.S. Cl. CPC C04B 41/009; C04B 28/04; C04B 28/08; C04B 2111/2061; C04B 2235/3232

(57) ABSTRACT

The construction system includes a composition that includes Portland cement, nano-TiO₂, and slag cement. The composition may also include water. The composition is cured via a CO₂ curing process to produce a self-cleaning photocatalytic composite with lower carbon footprint and may be more economically manufactured than known cement-based photocatalytic composites. The unveiled synergistic effect of using slag cement and applying a CO₂ curing process may reduce the porosity of the material and reduce the penetration of the pollutants that will accumulate in the surface. Thus, pollutants will be more exposed to UV light and decompose the pollutants in a greater rate. The construction system is self-cleaning in that water, such as from rainfall, may effectively clean the cured composition to reset the sequestering capabilities for the construction system to continue to remove toxic gases for the atmosphere.

### CROSS REFERENCE TO RELATED APPLICATIONS

The present application is a U.S. non-provisional application which claims the benefit of U.S. provisional application Ser. No. 63/411,879, filed Sep. 30, 2022, the content of which is incorporated by reference herein in its entirety.

### FIELD

The disclosure generally relates to cement-based materials and, more particularly, to environmentally friendly cement-based material systems.

### INTRODUCTION

This section provides background information related to the present disclosure which is not necessarily prior art.

Titanium dioxide is a well-known catalyst used for air purification and self-cleaning. The addition of titanium dioxide nanoparticles (nano-TiO₂) to cementitious materials produces a photoactive material with two bands, a valence band (with electrons) and a conduction band (without them). The exposure of cementitious composites containing nano-TiO₂ to light, with wavelengths shorter than 415 nm (which corresponds to nano-TiO₂ band gap), may induce an electron promotion from the valence band to the conduction band, leaving a hole on it. These holes can interact with hydroxide ions and produce hydroxyl radicals (OH—). Conversely, electrons can react with molecular oxygen and form superoxide radical-anion (O₂—). These components have some beneficial properties, such as the ability to degrade some microorganisms.

The photocatalytic effect can be divided into two different steps: (i) depollution and (ii) self-cleaning. Depollution is defined as the ability to remove toxic gases (e.g., NOx, SOx, VOCs) from the air. Self-cleaning refers to the ability to eliminate pollutants from the material without the use of manual work.

A large and growing body of literature has investigated the influence of nano-TiO₂ addition on the self-cleaning performance of cementitious materials. The percentage of nano-TiO₂ addition positively influences the effectiveness since the higher the amount of nano-TiO₂, the higher the self-cleaning activity of the material. In known systems, a minimum of 4% of nano-TiO₂ (by weight of cement) is required to provide the material with photocatalytic properties and to meet the thresholds required by photocatalysis standards. Nonetheless, the exposed area of the material could be a key factor regardless of the amount of nano-TiO₂ used. For example, coatings may produce higher degradation of pollutants than mortars with nanoparticles despite having a lower total amount of nanoparticles by volume. In addition, a rough surface increases the efficacy due to its higher surface area. Previous researchers also observed that samples exposed to accelerated durability tests showed lower self-cleaning activity than the non-exposed specimens. Even though the effectiveness is reduced over time, cementitious materials modified with nano-TiO₂ can be effectively reused several times with or without a cleaning process.

Apart from its widely known effect on self-cleaning, recent studies by the inventors showed that nano-TiO₂ might promote the CO₂ uptake of hardened cementitious materials. While one of our previous studies evidenced that using 0.5% of nano-TiO₂ increased the carbonation of mortars during the grinding process, in another study we have observed that nano-TiO₂ addition might accelerate the CO₂ capture of hardened cement pastes. Previous literature has studied the potential applicability of carbonation technology (CO₂ curing) in conventional cementitious materials. This type of curing could be reproduced in the precast industry. For instance, Monkman and Shao presented a feasible method to incorporate CO₂ or accelerated curing into manufactured concrete products. The active or accelerated carbonation of cementitious composites is nowadays a subject undergoing intense study thanks to its promising results in terms of strength, microstructure, sustainability, and durability improvements.

When cementitious composites are exposed to CO₂ at early ages, the CO₂ may react with their cement hydration products [e.g., calcium hydroxide (CH or Ca(OH)₂) or calcium silica hydrate (C—S—H or (CaO)ₓ·(SiO₂)_{y}·(H₂O)_{z})] and/or anhydrous cement phases [e.g., alite, C₃S or 3(CaO)·SiO₂, and belite, C₂S or 2(CaO)·SiO₂] to produce calcium carbonate (CaCO₃), among other compounds. The mechanism reactions are shown in Eq. 1-4:

Ca(OH)₂+CO₂→CaCO₂+H₂O (1)

(CaO)ₓ(SiO₂)_{y}(H₂O)_{z}+xCO₂→xCaCO₃+y(SiO₂)(H₂O) [symbol] +(z−yt)H₂O (2)

3CaO·SiO₂+(3−x)CO₂+yH₂O→xCaO·SiO₂·yH₂O+(3−x)CaCO₃ (3)

2CaO·SiO₂+(2−x)CO₂+yH₂O→xCaO·SiO₂·yH₂O+(2−x)CaCO₃ (4)

It is well known that the carbonation process promotes the reduction of porosity since the molar volume of the CaCO₃ is higher than the molar volume of CH or C—S—H phases, among others. The porosity reduction improves the microstructure and reduces the penetration of pollutants inside the material. Besides increasing the CO₂ capture and enhancing the microstructure of the cementitious composites, the CO₂ curing may improve other cementitious materials properties (e.g., compressive strength or durability). Cementitious materials' durability is also enhanced, principally due to the improvement of the microstructure. Therefore, the denser microstructure after the CO₂ curing could prevent the ingress of chlorides or sulfates.

Furthermore, a recent study by the inventors has analyzed the influence of nano-TiO₂ on the CO₂ capture in cement pastes during CO₂ curing. The study showed that the use of nano-TiO₂ might increase the CO₂ uptake during CO₂ curing while increasing the material's strength. Both effects (higher CO₂ uptake and strength improvement) could be related to the enhancement of the microstructure made by the nanoparticles. On the other hand, changes on cement pastes' microstructure may affect the material's self-cleaning activity. No known investigations have studied the effect of CO₂ curing on the self-cleaning activity of cementitious materials containing nano-TiO₂.

Accordingly, there is a continuing need for a more sustainable construction method that may remove toxic gases from the air and may eliminate pollutants from the construction material without requiring manual work while reducing the amount of cement required for its production.

### SUMMARY

In concordance with the instant disclosure, a more sustainable construction method that may remove toxic gases from the air and may eliminate pollutants from the construction material without requiring manual work, with a reduced carbon footprint and low content of nano-TiO₂, has surprisingly been discovered.

The construction material system includes a composition that includes Portland cement, nano-TiO₂, and slag cement. During the manufacturing of the construction material system, the composition also includes water. The Portland cement may be between around 0.1% to 97% by weight. The nano-TiO₂ may be between around 0.1% to 3.9% by weight of nano-TiO₂. The slag cement may be between around 0.1% to 60% by weight. The mixtures may be cured by a CO₂ curing process which captures CO₂ during the curing process. Advantageously, the mixtures with slag cement present a lower carbon footprint than mixtures with Portland cement only. Desirably, it is observed that both CO₂ curing and the utilization of slag cement as a binder increases the photocatalytic activity of the material.

In a specific example, the construction material system was compared to known compositions as a reference mixture. The reference mixture contained only Portland cement and water, with a water-to-binder ratio of 0.55 (by weight). Thus, cement was the only binder in this reference mixture (which represents a typical cement paste mixture). Then, another mixture was formulated where 30% of Portland cement (by weight) was substituted by slag cement. Additionally, six mixtures were formulated (and tested) using as a reference both previously described reference systems (the first with Portland cement only and the second with 70% Portland cement and 30% slag cement, as the binder) and substituting 0.5%, 1%, and 2% of the weight of the binder (Portland cement plus slag cement) by nano-TiO₂. While these are the tested formulations, additional formulations with different proportions of these constituents may be used.

Advantageously, it was surprisingly found that the combination of using a partial replacement of Portland cement by slag cement and a CO₂ curing process increased the photocatalytic activity of samples with around 2% nano-TiO₂ to reach the thresholds values to be considered a photocatalytic material according to the UNI 11259 (Determination of the photocatalytic activity of hydraulic binders—Rhodamine test method). As a specific example, the construction material system of the present disclosure uses around a 30% replacement of Portland cement with slag cement, and further utilizing a CO₂ curing process, it is possible to create a composite that meets the photocatalytic thresholds using 2% of nano-TiO₂, while known mixtures that do not include both slag and CO₂ curing, require a minimum of 4% of nano-TiO₂ to provide the composite with photocatalytic properties. Desirably, using less nano-TiO₂ than the known minimum of 4% weight percent can considerably lower the cost of the photocatalytic composite and may increase its sustainability, as a whole, while still providing the benefit of effectively sequestering toxic gases. Further, the composition may advantageously clean and/or reset the sequestering capabilities, without requiring manual work (self-cleaning ability). For instance, water via rainfall may effectively clean the cured composition to reset the sequestering capabilities.

Various ways of manufacturing the construction system are provided. For instance, the method may include a step of mixing around 0.1% to 83% by weight of Portland cement, around 0.1% to 3.9% by weight of nano-TiO2, and around 0.1% to 83% by weight of slag cement. The mixture may be disposed into a predetermined position. For instance, the predetermined position may be a mold, a form, a coating, cement paste, stucco, concrete, and/or mortar precast slabs, bricks, etc. Next the disposed mixture may be carbon cured.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a line graph illustrating a particle size distribution of ordinary portland cement (OPC) and slag cement (Slag), according to one embodiment of the present disclosure;

FIG. 2A is a line graph illustrating a self-cleaning activity after exposure to UV light in mixtures without slag cement, according to one embodiment of the present disclosure;

FIG. 2B is a line graph illustrating a self-cleaning activity after exposure to UV light in mixtures with 30% slag cement, according to one embodiment of the present disclosure;

FIG. 3A is a line graph illustrating a relation between total color variation (ΔE (CIELab units)) after 24 hours of UV light exposure vs. nano-TiO₂ percentage, according to one embodiment of the present disclosure;

FIG. 3B is a bar graph illustrating an improvement of ΔE (CIELab units) after 24 hours of UV light exposure compared to mixture with 0% slag and no nano-TiO₂, according to one embodiment of the present disclosure;

FIG. 4A is a binary processed image, used for macroporosity examinations, of a Sample 1 with no nano-TiO₂ and no slag cement;

FIG. 4B is a binary processed image, used for macroporosity examinations, of a Sample 2 with no nano-TiO₂ and no slag cement;

FIG. 4C is a binary processed image, used for macroporosity examinations, of a Sample 3 with no nano-TiO₂ and no slag cement;

FIG. 4D is a binary processed image, used for macroporosity examinations, of a Sample 1 with no nano-TiO₂ but including slag cement;

FIG. 4E is a binary processed image, used for macroporosity examinations, of a Sample 2 with no nano-TiO₂ but including slag cement;

FIG. 4F is a binary processed image, used for macroporosity examinations, of a Sample 3 with no nano-TiO₂ but including slag cement;

FIG. 5A is a binary processed image, used for macroporosity examinations, of a Sample 1 with 2% nano-TiO₂ and no slag cement;

FIG. 5B is a binary processed image, used for macroporosity examinations, of a Sample 2 with 2% nano-TiO₂ and no slag cement;

FIG. 5C is a binary processed image, used for macroporosity examinations, of a Sample 3 with 2% nano-TiO₂ and no slag cement;

FIG. 5D is a binary processed image, used for macroporosity examinations, of a Sample 1 with 2% nano-TiO₂ but including slag cement;

FIG. 5E is a binary processed image, used for macroporosity examinations, of a Sample 2 with 2% nano-TiO₂ but including slag cement;

FIG. 5F is a binary processed image, used for macroporosity examinations, of a Sample 3 with 2% nano-TiO₂ but including slag cement;

FIG. 6A is a bar graph illustrating a density of mixtures having 2% nano-TiO₂, according to one embodiment of the present disclosure;

FIG. 6B is a line graph illustrating thermogravimetric analysis results of mixtures having 2% nano-TiO₂, according to one embodiment of the present disclosure;

FIG. 7 is a line graph illustrating the x-ray powder diffraction results for samples with 2% nano-TiO2 and both types of curing (normal curing and CO₂ curing), according to one embodiment of the present disclosure;

FIG. 8A is a bar graph illustrating results for a standard photocatalytic test of mixtures with 2% nano-TiO₂ after four hours of UV light exposure, according to one embodiment of the present disclosure;

FIG. 8B is a bar graph illustrating results for a standard photocatalytic test of mixtures with 2% nano-TiO₂ after twenty-four hours of UV light exposure, according to one embodiment of the present disclosure;

FIG. 9 is a flowchart depicting a method for manufacturing the construction system, according to one embodiment of the present disclosure; and

FIG. 10 is a box diagram depicting the construction system, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “self-cleaning” may be understood as the ability to eliminate pollutants from a material without the use of manual work.

As used herein, the term “depollution” may be understood as the ability to decompose or remove toxic gases (e.g., NOx, SOx, VOCs) from the atmosphere.

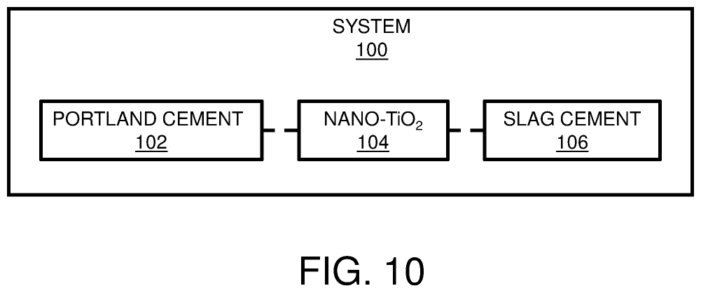

As shown in FIG. 10, the system 100 includes a composition that includes Portland cement 102, a photocatalytic material 104, and slag cement 106. The composition may also include water. The Portland cement 102 may be between around 0.1% to 83% by weight. In a more specific example, the Portland cement 102 may be between around 20% to around 60% by weight. The photocatalytic material 104 may more specifically be a metal oxide catalyst. In a specific example, the catalyst 104 may include TiO₂. Provided as a non-limiting example, the TiO₂ 104 may be provided in a nanostructured form. The nano-TiO₂ 104 may be between around 0.1% to around 5% by weight. In a more specific example, the nano-TiO₂ 104 may be between around 1% to around 3% by weight. The slag cement 106 may be between around 0.1% to around 83% by weight. In a more specific example, the slag cement 106 may be between around 5% to around 40% by weight. In a specific example, the water may be between around 16% to around 38% by weight. In a more specific example, the water may be around 35% by weight. The composition may be cured by a carbon dioxide curing process. Advantageously, the composition may effectively remove toxic gases from the atmosphere while requiring less than four percent by weight of nano-TiO₂ 104. Desirably, using less nano-TiO₂ 104 can considerably lower the cost of construction and may increase the sustainability of nano-TiO₂ 104, as a whole, while still providing the benefit of effectively sequestering toxic gases. Further, the composition may be advantageously clean and/or reset the sequestering capabilities, without requiring manual work. For instance, water via rainfall may effectively clean the cured composition to reset the sequestering capabilities. A skilled artisan may select other suitable materials and/or similar relative proportions of binders (slag, Portland cement, and nano-TiO₂), and with additional materials such as aggregates and/or fibers and variations of the water-to-binder ratio to form the system 100.

In certain circumstances, a CO₂ curing process may be required when low percentages of nano-TiO₂ 104 are used (for example around 2%). In a specific example, a reference mixture, which represents known construction systems, may contain only Portland cement and water, with a water-to-binder ratio of 0.55 (by weight). Thus, Portland cement is the only binder in this reference mixture (which represents a typical cement paste mixture). Then, a second mixture was formulated where 30% of Portland cement (by weight) was substituted by slag cement 106. Additionally, six mixtures were formulated (and tested) using as a reference both previously described systems (the first with Portland cement only and the second with 70% Portland cement 102 and 30% slag cement 106, as the binder) and substituting 0.5%, 1%, and 2% of the weight of the binder (Portland cement 102 plus slag cement 106) by nano-TiO₂ 104. While these are the tested formulations, it should be appreciated that additional formulations with different proportions of these constituents may be used. The mixtures may be cured by a CO₂ curing process capturing CO₂ during the curing process. The mixtures with slag cement 106 desirably present a lower carbon footprint than mixtures with Portland cement only. It was observed that both CO₂ curing and the utilization of slag increases the photocatalytic activity of the material. Advantageously, it was found that the combination of using a partial replacement of Portland cement by slag cement 106 and a CO₂ curing process increased the photocatalytic activity of samples with 2% nano-TiO₂ 104 to reach the thresholds values to be considered a photocatalytic material according to the UNI 11259 (Determination of the photocatalytic activity of hydraulic binders—Rhodamine test method). Desirably, using less nano-TiO₂ 104 can considerably lower the cost of manufacturing the photocatalytic composite and may increase its sustainability, as a whole, while still providing the benefit of effectively sequestering toxic gases. Further, the composition of the present disclosure may advantageously clean and/or reset the sequestering capabilities, without requiring manual work (self-cleaning ability). For instance, water via rainfall may effectively clean the cured composition to reset the sequestering capabilities. In a specific example, the system 100 may be constructed with a composite having around 35.5% water by total weight of the composite, around 43.9% Portland cement 102 by total weight of the composite, around 1.3% by weight of nano-TiO₂ 104 by total weight of the composite, and around 19.3% by weight of slag cement 106 by total weight of the composite. The composite may then be cured by a CO₂ curing process.

In certain circumstances, the use of around a 30% replacement of Portland cement with slag cement 106, and further utilizing a CO₂ curing process, it desirably created a composite that meets the photocatalytic threshold using around 2% by weight of nano-TiO₂ 104. This reduction in nano-TiO₂ 104 is significant while known systems (which do not include slag cement and cured via a CO₂ curing process) require a minimum of 4% of nano-TiO₂ to provide the composite with photocatalytic properties. Without being bound to any particular theory, it is believed that the unveiled synergistic effect of using slag cement 106 and applying a CO₂ curing process that may reduce the porosity of the material, which may in turn reduce the penetration of the pollutants that will accumulate in the surface. Thus, pollutants will be more exposed to UV light and decompose the pollutants at an enhanced rate. Further, the lighter color of slag cement 106 may contribute to affect the albedo and therefore modified interaction of the material with the UV light.

Various ways of manufacturing the construction system 100 are provided. For instance, the method may include a step of mixing around 0.1% to 83% by weight of Portland cement 102, around 0.1% to 5% by weight of nano-TiO₂ 104, and around 0.1% to 83% by weight of slag cement 106. The mixture may be disposed into a predetermined position. For instance, the predetermined position may be a mold, a form, a coating, cement paste, stucco, concrete, and/or mortar precast slabs, bricks, etc. Next the disposed mixture may be carbon cured. It is also contemplated that the method 200 and/or the construction system 100 may be used in combination with aggregates to form mortars or concretes. It is also considered that the method 200 and/or the system 100 may be used individually as a surface treatment, a coating, a slurry, a paste, or other such applications. The use of reinforcement or the addition of extra components/compounds to avoid shrinkage is also considered.

Advantageously, the present disclosure enables the reduction of the carbon footprint of the photocatalytic self-cleaning composite. The carbon footprint is reduced through three mechanisms: (i) reduction of the amount of Portland cement 102 and using of a by-product instead, (ii) reduction of the amount of nano-TiO₂ 104 required, since nano-TiO₂ 104 production is carbon intensive, and (iii) capture of CO₂ during the CO₂ curing process.

Desirably, the present disclosure reduces the production cost of a photocatalytic self-cleaning composite. The cost is reduced through two mechanisms: (i) the reduction of nano-TiO₂ 104 required to produce cementitious composites with self-cleaning and/or photocatalytic capabilities, since nano-TiO₂ is expensive, and (ii) the reduction of Portland cement 102 used since slag cement 106 is more economically procured than Portland cement.

### EXAMPLE

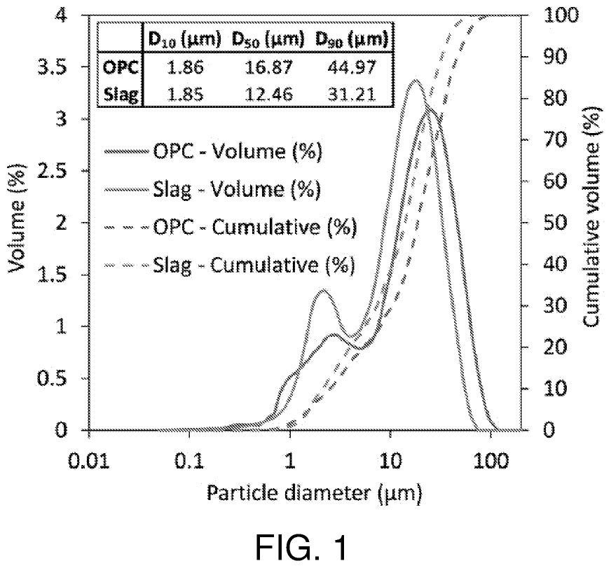

In certain circumstances, the system 100 may be made with various materials and/or compounds. For instance, the system 100 may be manufactured with water, Ordinary Portland cement (OPC) Type I (CEM I 52,5N-CP2) 102, slag cement Grade 100 106, and/or nano-TiO₂ 104. As shown on the following page, Table 1 illustrates a non-limiting example of the chemical composition of both types of cement employed (OPC 102 and slag cement 106), obtained by a Lab X500 XRF analyzer (Hitachi, Japan). While OPC Type 1 complies with the specification ASTM C150, slag cement 106 employed meets the specifications of ASTM C989 for Grade 100 slag cement 106. FIG. 1 presents the particle size distribution of both OPC 102 and slag cement 106 employed in this study, obtained by a PSA 1090 Series (Anton Paar, Austria). Slag cement 106 possesses finer particles than OPC, as shown in FIG. 1. Whereas OPC has a D50 of 16.87 μm, slag cement 106 possesses a D50 of 12.46 μm. Commercial nano-TiO₂ (Sigma-Aldrich (St. Louis, MO)) with a particle size of 21 nm (TEM—transmission electron microscopy) was used in this investigation. The nanoparticles possess 15% rutile and 85% anatase phases, a surface area of 35-65 m²/g, and a formula weight of 79.87 g/mol.

TABLE 1
Chemical composition (%) of both types
of cement used (OPC and slag cement).

| | OPC | Slag cement |
|---|---|---|
| CaO | 63.10 | 46.50 |
| SiO₂ | 20.53 | 34.03 |
| Al₂O₃ | 5.21 | 8.62 |
| SO₃ | 3.16 | 1.59 |
| Fe₂O₃ | 2.82 | 0.66 |
| MgO | 2.65 | 12.29 |
| TiO₂ | 0.32 | 0.43 |
| Na₂O | 0.14 | 0.36 |
| P₂O₅ | 0.10 | less than0 |
| ZnO | 0.04 | 0.01 |
| Mn₂O₃ | 0.04 | 0.50 |
| SrO | 0.03 | 0.08 |
| Cr₂O₃ | 0.01 | 0.01 |

In a specific example, a total of eight different cement pastes, with water-to-binder ratio of 0.55, were prepared with four different percentages of nano-TiO₂ 104 (0%, 0.5%, 1%, 2%) and two slag cement 106 content; 0% (i.e., 100% OPC), and 30% (i.e., with a substitution of 30% OPC by slag). Both percentages of nano-TiO₂ 104 and % of slag are calculated based on the total weight of binder. As shown below, Table 2 lists the mix proportions of each cement paste.

TABLE 2
Mix proportions of cement paste mixtures.

| Mixture | OPC (g) | Slag cement (g) | nano-TiO₂ (g) | w/b |
|---|---|---|---|---|
| P0-R | 1874.8 | 0.0 | 0.0 | 0.55 |
| P0.5-R | 1865.4 | 0.0 | 9.4 | 0.55 |
| P1-R | 1856.0 | 0.0 | 18.7 | 0.55 |
| P2-R | 1837.3 | 0.0 | 37.5 | 0.55 |
| P0-S | 1312.4 | 562.4 | 0.0 | 0.55 |
| P0.5-S | 1303.0 | 562.4 | 9.4 | 0.55 |
| P1-S | 1293.6 | 562.4 | 18.7 | 0.55 |
| P2-S | 1274.9 | 562.4 | 37.5 | 0.55 |

A total of eight slabs samples with 80×80×10 mm dimensions were cast for each mixture to perform the self-cleaning activity test. Four samples of each mixture were cured in normal conditions, while the other four samples of each mixture were CO₂ cured. All samples were demolded after 12 hours and left for 12 more hours in an environmental chamber with T=23° C. and RH=50%. After that, the CO₂ cured samples (named CC samples) were moved to a CO₂ chamber with 20% CO₂ concentration and T=23° C. for 12 hours. The other four samples of each mixture, named as normal cured (NC) samples, were placed in an environmental chamber with T=23° C. and RH>90%. CC samples were moved to the same environmental chamber after the 12 hours of carbonation. All samples were left in the environmental chamber (T=23° C. and RH>90%) for 6.5 days more. Then, the samples were removed from the environmental chamber and air-cured (T=23° C. and RH=50%) for seven days.

Besides, cubic samples (50.8×50.8×50.8 mm) for density determination, and prismatic samples (160×40×40 mm) for macroporosity examination were produced for selected mixtures. The prismatic samples were cured following the same procedure as the slabs. The curing procedure of the cubic samples was also the same procedure, except for the moist curing in the environmental chamber (T=23° C. and RH>90%). In the case of the cubic samples, samples were left in that environmental chamber for 26.5 days. As shown below, Table 3 presents an overview of the samples made, including curing age and tests performed.

TABLE 3
Overview of samples made in this study,
including curing age and tests performed.

| Sample | | Curing | |
|---|---|---|---|
| type | Sample dimensions | age | Experiments conducted |
| Slab | 30 × 10 × 10 mm | 14 days | Self-cleaning and TGA |
| Prism | 160 × 40 × 40 mm | 14 days | Macroporosity |
| | | | examinations |
| Cubes | 50.8 × 50.8 × 50.8 mm | 28 days | Density measurements |

The changes on the self-cleaning activity of the samples were evaluated based on the Rhodamine B (RhB) degradation under ultraviolet (UV) light. Cement pastes were sprayed with an RhB solution with a concentration of 0.1\hat{ }A±0.01 g/l on the top surface of the samples. The specimens remained 24 hours in a dark environment to allow them to dry. The color was then measured using a Ci62 portable spectrophotometer, commercially available from X-Rite® in Grand Rapids, MI. After that, samples were exposed to a UV lamp WTC 36L-110 with an irradiance of 0.28 mW/cm² and a wavelength of 368 nm. In some standards, the self-cleaning activity is only measured at certain exposure times (e.g., 4 hours and 24 hours). In this investigation, the color was measured at different exposure times (0 hours, 0.5 hours, 1 hours, 2 hours, 3 hours, 4 hours, 5 hours, 6 hours, 7 hours, 8 hours, 24 hours) for all samples to study the color degradation over time. Four samples of each mixture were used in the self-cleaning test. For each sample, four points were employed to measure the color variation. A total of 16 color measurements were obtained per mixture and UV exposure time. The higher the overall color variation (ΔE), the higher the self-cleaning activity of the material.

Color measurements were processed using CIELab™ color space which is commercially available from Commission Internationale de l'Éclairage. This space comprises three color coordinates: L* (measuring brightness or, in other words, hues from black to white), a* (measuring hues from red to green), and b* (measuring hues from yellow to blue). The overall color variation (ΔE) was calculated using those color coordinates in Eq. (5). L*, a*, b*t=parameters of the color coordinates after the umpteenth hour of UV light exposure; L*0, a*0, b*0=parameters of the color coordinates before the UV light exposure.

ΔE=\sqrt{(Lₜ*−L₀*)²+(aₜ*−a₀*)²+(bₜ*−b₀*)²} (5)

Besides, for selected mixtures, additional self-cleaning activity tests were repeated following the specifications of standard UNI 11259. The new tests were conducted using the irradiance value specified by the UNI 11259 (3.75±0.25 W/m2), as reported in section 4.2 of the manuscript.

After the self-cleaning test, samples of the reference mixtures (P0-R and P0-S) and mixtures with higher self-cleaning activity observed (P2-R and P2-S), were used for thermogravimetric analysis (TGA) and x-ray diffraction analysis (XRD). These samples were employed to further investigate the synergistic effects of nano-TiO₂ 104, slag cement 106, and CO₂ curing. First, samples were pretreated with a solvent to remove the free water in the samples. Each sample was then roughly ground and 5 g of each were soaked in a container with iso-propanol (50 mL). Fifteen minutes later, the specimens were dried in an oven at 40° C. to remove the excess solvent. After 10 min in the oven, samples were ground with a mortar and pestle and sieved using No. 200 sieve (75-μm).

Thermogravimetric analysis was conducted with a 2050 Thermogravimetric Analyzer (TA Instruments, New Castle, DE). Between 20 and 50 g of powdered samples were analyzed using a platinum pan with 20 psi pressure and 60 mL/min purge flow. Before the heating, samples remained for two minutes in isothermal conditions. Then, specimens were heated up 900° C. with a rate of 10° C./min, and their mass loss versus temperature was recorded.

TGA results were also used to estimate the CO₂ uptake during the CO₂ curing. The CO₂ uptake can be calculated with the difference between the calcium carbonate (CaCO₃) content of the CO₂ cured sample (CC) and the normal cured sample (NC). While Eq. (6) shows how to calculate the CaCO₃ content, Eq. (7) displays how to obtain the CO₂ capture based on the CaCO₃ content difference. CaCO₃ is the calcium carbonate content (in g/100 g); 100.1 and 44.0 are the molar mass of CaCO₃ and CO₂, respectively; MC is the initial mass of the sample (in g); and (Mstart CaCO₃) and (Mend CaCO₃) are the masses (in grams) of the sample at the start and endpoint for CaCO₃ decomposition, respectively.

$${CaCO}_{3} ( g / 100 g ) = 100 \cdot \frac{100.1}{44.} \cdot \frac{1}{{M}_{c}} \cdot [ ( {M}_{start}^{{CaCO}_{3}} ) - ( {M}_{end}^{{CaCO}_{3}} ) ] \qquad ( 6 )$$

$${CO}_{2} uptake ( g / 100 g ) = [ ( {CaCO}_{3}^{CC . sample} ) - ( {CaCO}_{3}^{NC . sample} ) ] \cdot \frac{44.}{100.1} \qquad ( 7 )$$

“CO₂ uptake” is the absorbed carbon dioxide content in (g/100 g); CaCO₃ CC, sample and CaCO₃ NC, sample are the CaCO₃ contents (in g/100 g) of the CO₂ and normal cured samples, respectively; and 44.0 and 100.1 are the molar mass of CO₂ and CaCO₃ respectively.

Using the same thermogravimetric analysis sample preparation, powder samples were prepared and employed for X-Ray powder diffraction (XRD). A Siemens (Munich, Germany) D500 machine was used in the XRD test. The 2θ-range was 5-65° at a 0.02°/sec scanning rate. The experiment was conducted at 50 kV and 30 mA.

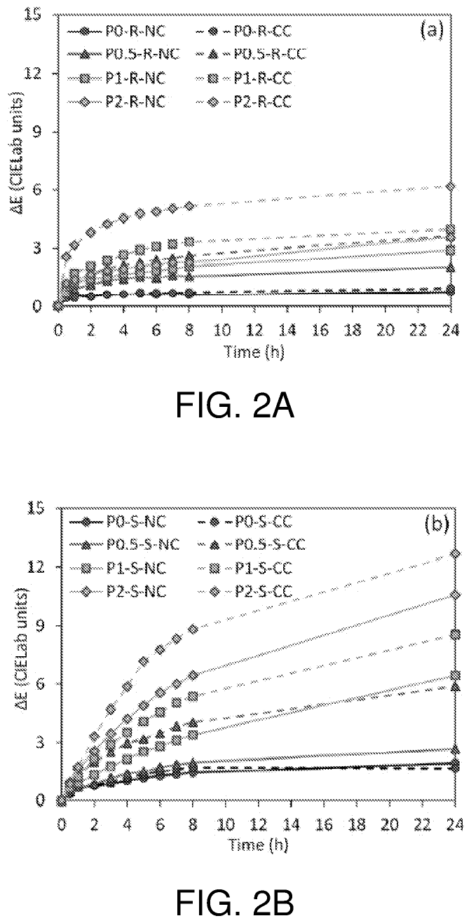

Density measurements were conducted on selected mixtures to analyze the effect of slag and CO₂ curing. For these analyses, reference mixtures (P0-R and P0-S) and the specimens with the highest self-cleaning activity observed (P2-R and P2-S), were selected. Six cubic samples of each selected mixture were cast to obtain the density in oven-dry condition after 28 days. FIG. 2 shows the curing timeline of both CC and NC cubic samples. Cubic samples with dimension of 50.8×50.8×50.8 mm (2×2×2 in) were used. All the studied specimens were first placed in an oven at 105° C. for at least 2 days, or until their weight was constant. Then, the weight was measured, and the density was obtained using Eq. 8. ρ_{d}=density in oven-dry condition (in kg/m³); Md=oven-dry mass (in kg); V=volume of the samples (in m³).

$${ρ}_{d} = \frac{{M}_{d}}{V} \qquad ( 8 )$$

The prismatic samples (160×40×40 mm) were employed for macroporosity examination using 2D cross-sectional images. Three samples of each selected mixture were analyzed. First, those samples were cut in half using an IsoMet Low-Speed precision cutter (Buehler, Lake Bluff, IL). Then, the cut surface was polished using Hillquist (Denver, Colorado, USA) mesh flat diamond laps of 45, 30, and 15 μm, used from coarser to finer. Polished surface was painted with a Sharpie black marker and pores were filled with white barium sulfate powder. After this step, a 48-megapixel camera was used to photograph the specimens. The captured images were imported to ImageJ software and converted from RGB color feature to 8-bit greyscale (binary pictures). The lower and upper limits of the threshold histogram were defined as 100 and 255 respectively to avoid noise, and the same thresholds were used for all analyzed samples. Next, the image was scaled, considering that the cross-sectional area was 40×40 mm. Finally, macroporosity was automatically examined using the software.

FIG. 2 presents the overall color variation (ΔE) from the RhB degradation test for all studied mixtures. FIG. 2a exhibits the results for mixtures with no slag, whereas FIG. 2b displays the results of mixtures containing slag. Each ΔE data point represents the average of 16 color measurements performed per mixture and UV exposure time. The standard deviation of each of the represented data points is less than 20%. As expected, the use of nano-TiO₂ 104 increased the ΔE. Thus, the higher the nano-TiO₂ 104 percentage, the higher the dye degradation and, therefore, the self-cleaning activity. Samples with no nanoparticles showed negligible self-cleaning activity compared to specimens with nano-TiO₂ 104. It is also observed that the CO₂ curing increased the self-cleaning activity of all mixtures containing nanoparticles. FIG. 2b shows that the use of slag increased the self-cleaning activity of normal cured cement pastes compared to NC mixtures with 0% slag and the same percentage of nanoparticles.

Results suggest that the combination of nano-TiO₂ 104 addition, slag cement 106 and CO₂ curing may produce a beneficial synergistic effect in terms of self-cleaning activity. Nonetheless, at low UV exposure time (lower than 2 hours), specimens with 0% slag presented comparable self-cleaning activity or even higher compared to their corresponding mixture with slag.

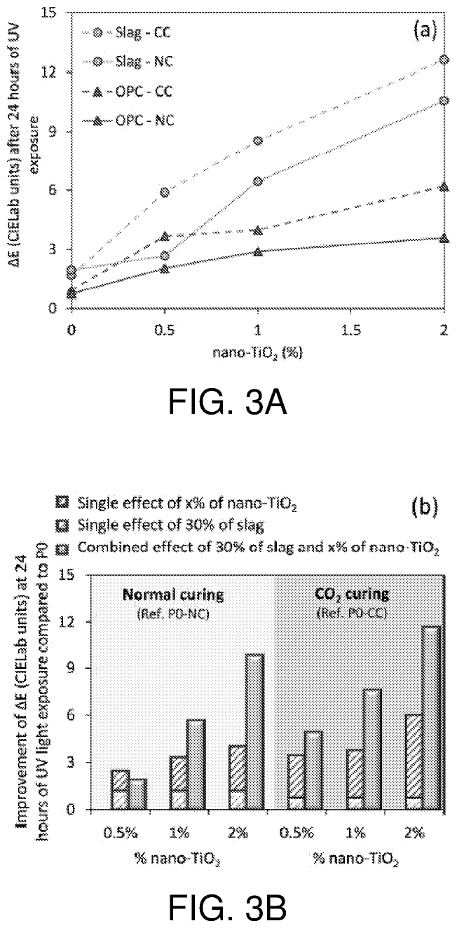

To assess the interrelated effects between CO₂ curing, slag, and nano-TiO₂ 104 addition on the self-cleaning activity, FIG. 3a shows the relation between total color variation (ΔE) after 24 hours of UV light exposure vs. nano-TiO₂ percentage. The self-cleaning activity was increased with an increase in the nanoparticles' percentage for all studied mixtures. Likewise, mixtures containing slag presented higher dye degradation than their corresponding mixtures without slag.

According to the results, CO₂ curing increased the self-cleaning activity of all studied mixtures containing nanoparticles. Without being bound to any particular reason, it is believed this may be due to the porosity reduction during CO₂ curing. Previous investigations pointed out that the carbonation process during CO₂ curing reduces cementitious materials' porosity. Besides, researchers showed that materials with lower porosity possess higher self-cleaning activity since the pollutants penetrate less into the material and can be easily removed since they are more exposed to UV light. Therefore, CO₂ curing may be beneficial to increase the self-cleaning activity due to their well-known porosity reduction. In addition, since slag cement 106 used is finer than OPC (FIG. 1), the use of slag may have produced a decrease in porosity, and this reduction might be the reason behind the observed positive influence of slag in terms of self-cleaning performance, as FIG. 2 exhibited. Therefore, further experiments were performed to better validate this observation.

Moreover, results suggest that using both materials (nano-TiO₂ 104 and slag cement 106) may produce a synergistic effect in terms of self-cleaning activity improvement. For instance, in NC samples, while specimens with 2% nano-TiO₂ 104 and no slag showed degradation of 3.6 after 24 hours, and samples with slag and no nanoparticles showed a value of 1.9, the samples that combined both slag and 2% nano-TiO₂ 104 the color variation (ΔE) was 10.6.

FIG. 3b exhibits the improvement of ΔE after 24 hours of UV light exposure compared to the mixture with 0% slag and no nano-TiO₂ (P0). The combined use of slag cement 106 and nanoparticles produced a synergistic effect in all samples (except for normal cured samples with 0.5% of nano-TiO₂). That means that, for each nanoparticles' percentage, the effect of combining slag and nano-TiO₂ 104 on the self-cleaning activity is higher than the sum of the single effects on the self-cleaning activity produced by using slag and nanoparticles separately. FIG. 3b also shows that the higher the nano-TiO₂ percentage, the higher the synergistic effect of slag and nanoparticles.

Macroporosity examinations were carried out in normal cured samples to analyze the effect of slag in terms of porosity reduction. Samples with no nano-TiO₂ (P0-R and P0-S) and samples with the percentage of nano-TiO₂ 104 that showed the highest self-cleaning activity (P2-R and P2-S) were selected to perform this test.

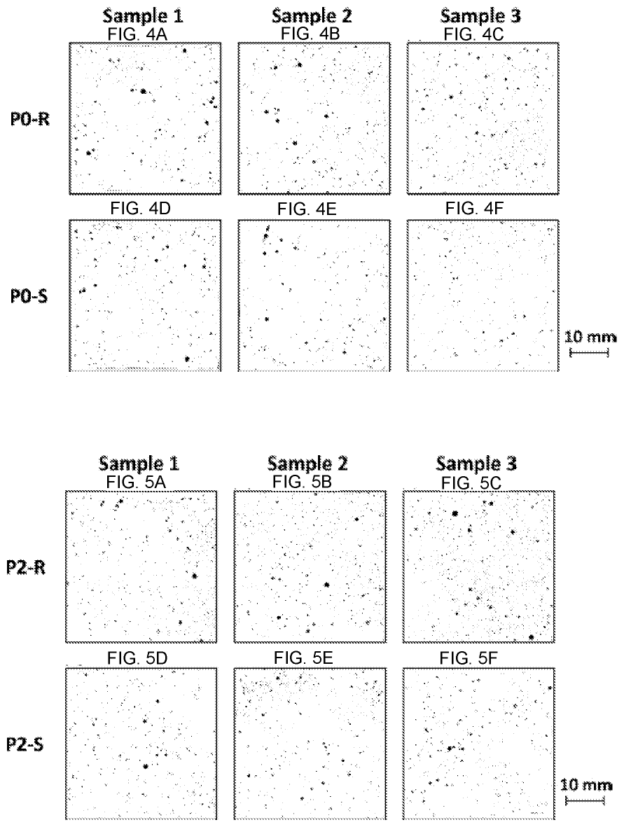

FIG. 4 exhibits the b/w binary processed images of samples with no nano-TiO₂ used for the macroporosity examinations. While FIGS. 4a, 4b and 4c show samples with no slag cement, FIGS. 4d, 4e and 4f present the specimens containing slag.

When no nano-TiO₂ was used, as shown in FIG. 4, the use of slag showed an average decrease in macroporosity of 25.8% (with a standard deviation of 14.9%) compared to the reference without slag. This porosity reduction could be the reason behind the increase of the self-cleaning activity when slag is added.

FIG. 5 exhibits the b/w binary processed images of samples with 2% nano-TiO₂ 104 used for the macroporosity examinations. While FIGS. 5a, 5b, and 5c show samples with no slag cement, FIGS. 5d, 5e and 5f present the specimens containing slag.

The macroporosity examinations of samples containing 2% nano-TiO₂ 104, as shown in FIG. 5, have shown that the use of slag cement 106 reduced 22.4% (with a standard deviation of 9.8%) the total macroporosity compared to the mixture with 2% nano-TiO₂ 104 and no slag. Considering the porosity reduction made by the slag cement 106 in all studied mixtures (with and without nano-TiO₂), results suggest that the addition of 30% slag cement 106 produced a filling effect in those mixtures, reducing their macroporosity.

Moreover, adding nano-TiO₂ 104 and slag cement 106 may advantageously increase the material strength since porosity is the property that influences the strength the most in cementitious composites. This increase in the material strength may also lead to a decrease in the cement content required to obtain a given strength and, therefore, it may imply an enhancement of the material sustainability.

For every reference mixture studied, it was observed that the higher the percentage of nano-TiO₂ 104, the higher the photocatalysis activity. Thus, to further investigate the effect of CO₂ curing and slag on the self-cleaning activity of cement pastes, additional tests were performed on the samples containing the highest percentage of nano-TiO₂ (2%) 104 of this study.

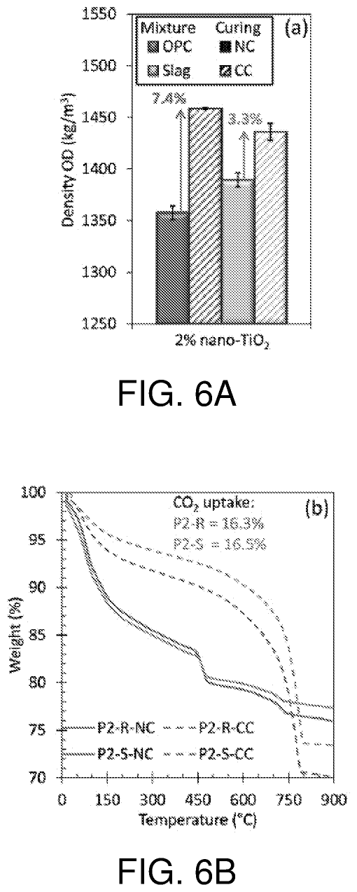

The influence of slag addition in terms of microporosity reduction was assessed in the previous section, as shown in FIGS. 4 and 5. To further investigate the effect of CO₂ curing on porosity reduction, density measurements in mixtures with 2% nano-TiO₂ 104 and both types of curing (normal curing and CO₂ curing) were performed. FIG. 6a shows the density in oven-dry condition (in kg/m³) for the cement pastes with 2% nano-TiO₂ 104 (P2-R and P2-S).

Results showed that the use of 30% slag cement 106 increased the density in NC samples. While samples with 2% of nano-TiO₂ 104 and no slag presented a density of 1357.8 kg/m³, specimens containing slag cement 106 and 2% of nano-TiO₂ 104 possesses a value of 1389.4 kg/m³. This observation agrees with the macroporosity examination results since the slag addition has decreased the macroporosity in normal cured samples. In a specific example, the construction system 100 may be graffiti resistant where the construction system 100 includes slag cement 106. Without being bound to any particular theory, it is believed the increased density of the cured composition may inhibit the saturation of paint, making it easier to remove paint with power washing alone and/or minimal scrubbing.

Regarding the effect of CO₂ curing, results exhibited a density increase in samples cured with CO₂ for both mixtures (with and without slag cement). The formation of CaCO₃ during the carbonation could explain the increase in density. It is known that CaCO₃ possesses a higher molar volume than the cement hydration products. Therefore, CO₂ would enter the permeable pores of the sample and react with the hydration products, forming denser layers of CaCO₃. As a result, the density would increase after CO₂ curing. However, CO₂ curing did not affect density in the same way in mixtures with 0% slag than pastes containing 30% slag. While the CO₂ curing increased 7.4% the density in samples with no slag and 2% nano-TiO₂ (P2-R), the mixture with slag cement 106 and 2% nano-TiO₂ (P2-S) experienced a lower density change (3.3%) due to CO₂ curing. As a result, the use of 30% of slag cement 106 in samples with CO₂ curing increased the density to a lesser extent when compared to samples without slag.

In mixtures containing 2% nano-TiO₂, the CO₂ curing increased the self-cleaning activity of samples with and without slag to a similar extent, as shown in FIG. 3a. Density results from FIG. 6a evidenced that samples with slag showed a lower increase of density than samples without slag during CO₂ curing. This observation might seem contradictory compared to self-cleaning activity results. However, in terms of self-cleaning effectiveness, the overall porosity reduction (or increase on overall density in 50.8×50.8×50.8 mm cube samples) is not as relevant as the reduction of the superficial porosity. And superficial porosity is a key factor in self-cleaning effectiveness. While the use of nano-TiO₂ and slag cement 106 may have a homogeneous effect in each part of the material, the CO₂ curing may be more concentrated on the surface. Nonetheless, a higher CO₂ penetration may imply a higher reduction of the overall material porosity, but it may not correlate with a higher reduction in the surface porosity. Consequently, results exhibited that the lower initial porosity of samples containing slag may induce a more localized and concentrated (due to the lower CO₂ penetration) carbonation of the material's surface, leading to a higher enhancement of the self-cleaning activity.

Considering the self-cleaning results, the mixtures with the nano-TiO₂ percentage that possessed the highest activity (P2-R and P2-S) were selected for thermogravimetric analysis to further analyze the synergistic effects of nano-TiO₂, slag, and CO₂ curing. TGA samples were prepared using slabs of 80×80×10 mm to focus on the surface effects of CO₂ curing. FIG. 6b displays the thermogravimetric curves of samples with 2% nanoparticles with and without slag cement 106 (P2-R and P2-S, respectively). Whereas the normal cured (NC) samples are represented as solid lines, CO₂ cured (CC) specimens are shown using dashed lines.

Regarding NC samples, the specimen with slag possessed a similar total amount of hydration products, but lower CH content than the specimen without slag. In CC samples, the use of slag in samples with 2% nano-TiO₂ slightly increased CO₂ uptake during CO₂ curing (16.3% vs. 16.5%, respectively). Thus, both mixtures (P2-R and P2-S) did not show a significant difference in terms of CO₂ capture during CO₂ curing.

Moreover, even though the use of slag cement 106 reduced the porosity, as shown in FIGS. 4 and 5, TGA results showed that samples with and without slag presented similar CO₂ uptake, as shown in FIG. 6.b, in 10 mm thick samples. Samples with slag possessed lower porosity than samples without slag under normal curing conditions, as shown in FIGS. 4 and 5. This lower porosity implies a lower CO₂ diffusion. Thus, samples with slag would present less CO₂ diffusion due to their lower porosity, but the same CO₂ uptake in the first 10 mm, as shown in FIG. 6b, than samples without slag. Therefore, according to the results, in samples with slag, carbonation will be more concentrated on the surface than in samples without slag. Carbonation reduces the porosity. Thus, a more concentrated CO₂ uptake in the surface implies a more concentrated reduction of porosity during CO₂ exposure. This concentration of the porosity reduction in the surface may explain that, even with the same level of carbonation, samples with slag present a higher enhancement of photocatalytic activity after CO₂ curing.

This is in accordance with self-cleaning results, as shown in FIG. 3b, since the combined effect of 2% nano-TiO₂ and 30% slag cement 106 produced a synergistic effect in enhancing the self-cleaning activity. As a result, CO₂ cured mixtures containing 2% nano-TiO₂ and slag cement 106 would enhance the self-cleaning activity. That could imply more beneficial effects, such as strength and durability improvement, due to the lower porosity after CO₂ curing.

In terms of hydration products, results showed that the use of CO₂ curing promoted the carbonation of the CH since both mixtures possessed a very low amount of Ca(OH)2 after CO₂ curing. In terms of carbonation of other hydration products, results suggest that the use of slag cement 106 is beneficial. Samples with 2% of nano-TiO₂ and slag cement 106 decreased more the hydration products content than the corresponding specimens without slag.

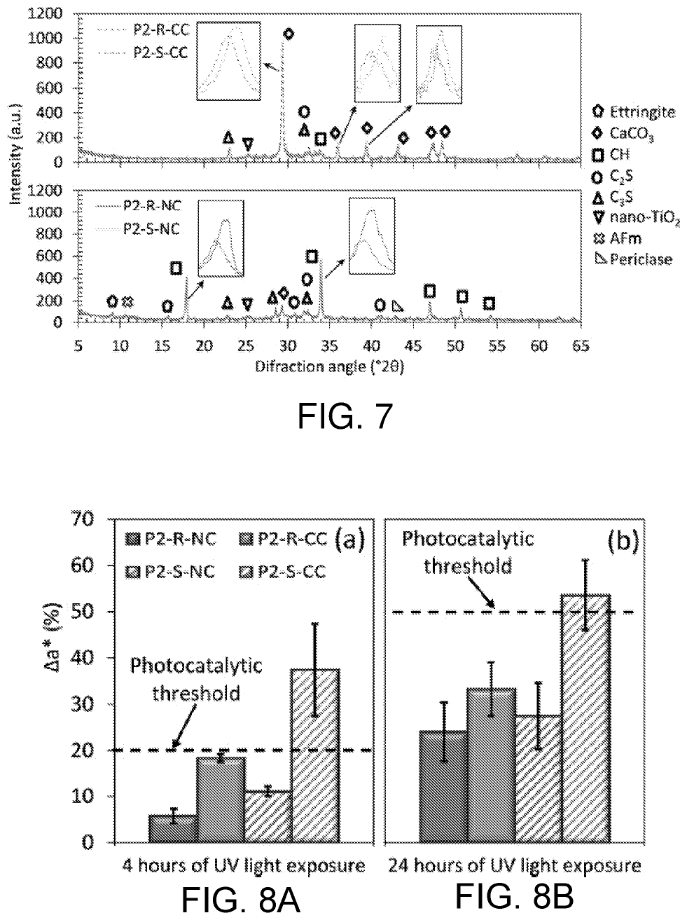

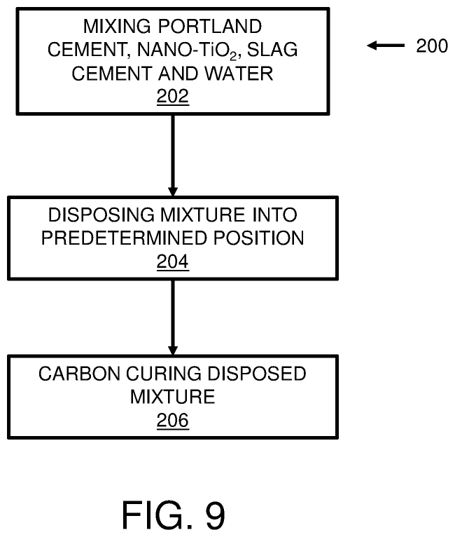

X-ray diffraction tests were performed in samples of the same mixtures used for thermogravimetric analysis (P2-R and P2-S). FIG. 7 presents the XRD results for samples with 2% nano-TiO₂ and both types of curing (normal curing and CO₂ curing).

Results showed that normal cured (NC) samples with no slag (P2-R-NC) possessed higher CH content than NC specimens with 30% slag cement 106 (P2-S-NC) since the CH peaks are more remarkable in P2-R-NC samples, as expected due to the lower OPC content of mixtures with slag. Results agree with the TGA data. In CO₂ cured samples (CC), results evidenced that the use of 30% slag cement 106 slightly increased the CO₂ capture since CaCO₃ peaks are slightly higher in these samples (P2-S-CC) than in samples with no slag (P2-R-CC). These observations suggest there is no significant variation in terms of CO₂ uptake due to the use of slag cement 106 in mixtures with nano-TiO₂.

Even though NC samples with slag (P2-S-NC) possessed less calcium hydroxide than NC specimens without slag (P2-R-NC), CO₂ cured samples with slag (P2-S-CC) showed a higher CaCO₃ content (and, thus, a higher CO₂ uptake) than CO₂ cured samples with no slag cement (P2-R-CC). This observation suggests that using slag cement 106 in cement pastes with 2% nano-TiO₂ does not reduce the CaCO₃ formation during CO₂ curing (i.e., it does not decrease the porosity due to CO₂ curing). This observation again agrees with the self-cleaning activity and TGA results, where the combined use of slag and CO₂ curing produced a cumulative effect in enhancing the self-cleaning activity.

The analysis of the photocatalytic properties of cementitious composites containing nano-TiO₂ after standard curing conditions has been widely studied throughout the literature. Consequently, some standards regulate whether a material could be considered as photocatalytic (e.g., UNI 11259).

According to UNI 11259, a material can be considered photocatalytic if the variation of the color coordinate a* (Δa*) exceeds 20% after 4 hours of irradiation and 50% after 24 hours irradiation. To analyze whether or not studied mixtures with 2% nano-TiO₂ comply with these thresholds of acceptancy, the same photocatalytic test setup as explained above, was used. Self-cleaning test section was employed, using the irradiance value specified by the UNI 11259 (3.75±0.25 W/m²).

FIG. 8 exhibits the results for the standard photocatalytic test of mixtures with 2% nano-TiO₂. This figure shows the Δa* at both 4 hours and 24 hours of UV light exposure. Results showed that the use of 2% nano-TiO₂ is not enough in conventional cement pastes (P2-R-NC) to provide this material with photocatalytic properties. This was expected since known methods have shown that usually a minimum of 3% of nano-TiO₂ is needed to make a photocatalytic cementitious composite. Besides, results evidenced that the use of slag cement 106 is beneficial to increase the photocatalytic properties in all studied mixtures. The use of slag increased the Δa* at both UV light exposure times, even though it was not enough to consider them photocatalytic. Samples with CO₂ curing exhibited higher Δa* than their corresponding mixtures with normal curing.

In terms of acceptability thresholds, only the mixture with 2% nano-TiO₂ 104, slag cement 106, and CO₂ curing met the requirements stated in the standard UNI 11259 to be considered a photocatalytic material. This mixture (P2-S-CC) possessed an average Δa* of 37.4% and 57.6% at 4 hours and 24 hours of UV light exposure, respectively. In contrast, the same mixture with normal curing (P2-S-NC) exhibited lower values (11.1% and 27.4%, respectively), which means that P2-S-NC cannot be defined as a photocatalytic material. Regarding mixtures with no slag, none showed a degradation higher than the acceptability thresholds neither at 4 hours nor 24 hours of UV light exposure.

Thus, results suggest that the combined use of slag cement 106 and CO₂ curing may become an enabling technology to make photocatalytic cementitious composites with lower percentages of nano-TiO₂.

The production of calcium carbonate during the CO₂ carbonation is very similar in samples with and without slag. Nonetheless, results suggest that, with normal curing, cement pastes containing slag and nano-TiO₂ have lower porosity than samples with nano-TiO₂ and no slag. This lower porosity in samples with slag could have produced higher and more concentrated surface carbonation during CO₂ curing due to the lower CO₂ diffusion. Consequently, the self-cleaning enhancement of those materials with low initial porosity would be higher than cementitious materials with high initial pore volume.

Moreover, results showed that reference cement pastes with 2% nano-TiO₂ (P2-R-NC) cannot be considered a photocatalytic material, based on the definition of standard UNI 11259. However, the combined use of both slag cement 106 and CO₂ curing produced a synergistic effect on cement pastes with nano-TiO₂ in terms of porosity reduction of the paste's surface, affecting the self-cleaning activity positively. As a result, the mixture with 2% nano-TiO₂ and 30% slag can be considered a photocatalytic material, according to UNI 11259 test, when cured with CO₂. Importantly, it was discovered that without CO₂ curing, the system 100 will not meet the photocatalytic thresholds stablished by the UNI 11259. Desirably, these results in the present disclosure show that the combination of using slag cement 106 and CO₂ curing may enable the production of photocatalytic cementitious composites with lower percentages of nanoparticles.

Advantageously, the construction system 100 may be a self-cleaning photocatalytic cementitious composite. Desirably, the construction system 100 may also include enhanced strength and durability compared to known cementitious composites. In other words, by combining Portland cement, water, slag cement, and small percentages of TiO₂, the present disclosure may be able to reach threshold values for the construction system 100 to be considered self-cleaning and have photocatalytic capabilities when convinced with a CO₂ curing method, allowing for the producution of low-carbon cementitious composites with less amount of TiO₂, specifically nano-TiO₂ in certain circumstances, to be used in comparison to known composite systems.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A composition for a construction material comprising:
around a tenth of a percent to around eighty-three percent Portland cement by total weight of the composite;
around a tenth of a percent to five percent of a photocatalytic material by weight of the composite; and
around a tenth of a percent to around eighty-three percent slag cement by total weight of the composite;
wherein the composition is cured by a CO₂ curing process.

2. The composition of claim 1, wherein the composition further includes water between a around sixteen percent to around thirty-eight percent by total weight of the composite.

3. The composition of claim 2, wherein the water is around thirty-five percent by total weight of the composite.

4. The composition of claim 1, wherein the Portland cement is between around twenty percent to around sixty percent by total weight of the composite.

5. The composition of claim 4, wherein the Portland cement is around forty-four percent by total weight of the composite.

6. The composition of claim 1, wherein the photocatalytic material is TiO₂.

7. The composition of claim 6, wherein the TiO₂ is nanostructured.

8. The composition of claim 7, wherein the nano-TiO₂ is between around one percent to around three percent by total weight of the composite.

9. The composition of claim 8, wherein the nano-TiO₂ is around one and three tenths of a percent by total weight of the composite.

10. The composition of claim 1, wherein the slag cement is between around five percent to around fourty percent by total weight of the composite.

11. The composition of claim 10, wherein the slag cement is around nineteen and three tenths of a percent by total weight of the composite.

12. The composition of claim 1, wherein the composition includes around thirty-five and one half of a percent water by total weight of the composite, around forty-three and nine tenths of a percent Portland cement by total weight of the composite, around one and three tenths of a percent by weight of nano-TiO₂ by total weight of the composite, and around nineteen and three tenths of a percent by weight of slag cement.

13. The composition of claim 1, wherein the composition is photocatalytic according to UNI 11259 requirements.

14. A method of manufacturing a composite system, the method comprising the steps of:
mixing around a tenth of a percent to around eighty-three percent Portland cement by total weight, around a tenth of a percent to around five percent of a photocatalytic material by total weight of the composite, and around a tenth of a percent to around eighty-three percent slag cement by total weight of the composite;
disposing the mixture into a predetermined position; and
CO₂ curing the disposed mixture.

15. The method of claim 14, further comprising a step of mixing water into the mixture.

16. The method of claim 14, wherein the CO₂ curing of the disposed mixture includes exposing the disposed mixture to around five percent to around thirty-five percent CO₂.

17. The method of claim 16, wherein the step of CO₂ curing further includes controlling the humidity at a predetermined level.

18. The method of claim 14, wherein the step of CO₂ curing the composite system is performed in at least one of a chamber, container, and an envelope.

19. The method of claim 18, wherein the step of CO₂ curing is performed for around twelve to twenty-four hours.

20. The method of claim 16, wherein the photocatalytic material is TiO₂ provided as less than three percent by total weight of the composite.
